(19) United States
(12) Patent Application Publication
(10) Pub. No.: US 2012/0095810 A1
(43) Pub. Date: Apr. 19, 2012

(54) LARGE SCALE PRIVACY PROTECTED CAMPAIGN MOBILIZATION METHOD

(76) Inventors: Wen Miao, Torrance, CA (US); David Landa, Celebration, FL (US)

(21) Appl. No.: 12/907,901

(22) Filed: Oct. 19, 2010

(51) Int. Cl. G07C 13/00; H04M 3/00

(52) U.S. Cl. 705/12; 379/265.02

(57) ABSTRACT

A System for conducting automated campaigns consists of an organization creating a caller list, a receiver list and initiating a click-to-call process whereby callers are prompted to become aware of a campaign and execute a click-to-call feature. The click-to-call feature alerts the organization that the caller will participate and causes the organization to connect with the receiver. Once contact is made with the receiver, the organization re-connects with the caller and bridges the contact between caller and receiver. In order to maintain security, callers are challenged by authentication protocols and pseudonymous display names are used to identify individual callers and receivers.

### BACKGROUND

Interactive voice response systems are known in the art, as are automated voting systems. There is a need, however, for an interactive voice response driven system that allows callers to respond to campaigns using a click-to-call feature that automatically connects them with a political representative or election administrator. These objects are achieved by the invention described in the appended Summary, Description and Claims.

### SUMMARY

A system of managing campaigns permits campaign effectiveness measurement and fosters participation. Using the System, an organization creates a campaign by creating a caller list of individually identified registered callers. The organization then creates a receiver list of individually identified caller targets. The organization then creates a campaign wherein callers are connected with receivers. The organization may pay the system provider for system usage, either according to total call time in the system, flat-fee usage on a periodic basis, or other similar means of charging for system usage.

Unregistered callers use system access devices to register for campaigns. A system access device may be the campaign website itself, a smart phone application, a general website, or interactive voice response system, such as an automated “800” number. An unregistered caller thereby creates a system account, registers for a campaign, and/or searches existing campaigns.

Upon registration, callers receive a display name proxy for the real identity of the caller. Receivers may also receive a display name. When a caller selects a receiver using a click to call feature, the organization automatically recognizes the receiver's preferred phone number, allowing the receiver's telephone number to remain anonymous.

Email click-to-call involves a caller receiving an email with one or more web-enabled hyperlink active buttons with messages such as “click here to call your representative.” These hyperlinks have embedded information uniquely identifying the caller, campaign, and receiver. After clicking the hyperlink, the caller may be required to enter or confirm a callback phone number.

Click-to-call via a campaign website involves a caller visiting the website of the organization administrator and finding one or more web enabled hyperlinks with messages such as “click here to call your representative.” These hyperlinks have embedded information that uniquely identifies the caller, campaign, and receiver. After clicking the hyperlink, the caller may be required to enter or confirm a callback phone number.

Click-to-call via a general campaign website involves a caller going to a more generalized site run by the organization where one or more hyperlinked connections allow a visitor to reach different campaigns. These hyperlinks also have embedded information that uniquely identifies the caller, campaign, and receiver. After clicking the hyperlink, the caller may be required to enter or confirm a callback phone number.

Click-to-call via smart phone application involves a caller using a smart phone application to cast a vote. The application may present the user with one or more web-enabled hyperlinks. These links have embedded information that uniquely identifies the caller, campaign, and receiver. After clicking the hyperlink, the caller may be required to enter or confirm a callback phone number.

Text-to-call via smart phone application uses text-to-call functionality to generate a callback. This type of system involves a caller sending a text message to a predetermined text message address to cause a callback. In the alternative, a user may first receive an initial text message from the organization and may reply to this message with a yes/no response, for example by sending a “1” for yes and a “2” for no. Once a callback is triggered, the system automatically determines the user's phone number from the address of the text message. The system then initiates a callback to the user an calls the user at the phone number used to send the text message. In the alternative, if the user includes a callback number in the body of the text, the system can call back the user at whatever number is specified in the text message. In other preferred embodiments, the text message may also include one or more web-enabled hyperlinks with embedded information that uniquely identifies the caller, campaign, and receiver. After clicking the hyperlink, the caller may be required to enter or confirm a callback phone number. It is also anticipated that other message services such as a Short Message Service (SMS), Multimedia Messaging Service (MMS) or similar protocol may be used for text-to-call communications.

Finally, it is possible to initiate a call back using an interactive voice response (IVR) number, such as an automated “800” type phone number. This type of caller option is intended for callers who are not able to make mobile/smart phone or computer contact. Once a caller connects to the RVR system, the caller can be instructed to enter identifying indicia such as a caller account number or PIN number which will identify the caller to the system. Also, if an unregistered caller contacts the system in this manner, they may be required to provide registration information prior to making a callback command.

In any of the above methods, a caller views a hyperlink within an email, text message, multimedia text message, smart phone application or other media. The hyperlink typically will contain a call instruction, such as “contact your representative.” Built into the link, an identification code identifies the caller, the receiver, and the campaign.

After receiving a campaign hyperlink, a caller selects it and is directed to an identification page. Registered callers may simply enter an email address or other indicia capable of being matched to the system database. Once identified, the caller may then be redirected to a caller information page populated with data reflecting the identity of the caller. At this stage, empty fields can be filled in by the caller for submission.

In the event the caller is unregistered, the unknown caller is prompted to complete a registration form. Registration can be as limited as requiring a caller name, or may be detailed, comprising the caller's name, address, phone number, etc. Upon submission of the identifying information, the system will add the newly registered caller to the system database. At this point, the organization will have the option of manually verifying the identity of and approving the caller, or bypass verification and transmit a “welcome” registration message. It is anticipated that the “welcome” message will comprise a hyperlink directing the caller to the caller information page.

Once a caller's identity has been confirmed, and the caller permitted to access the caller info page, the system database will use a predetermined algorithm to select from the receiver list proper recipients germane to the particular caller. In particular, the database may search the receiver list related to a specific campaign and the caller's unique zip code or location data to find the matching receiver and return a receiver's info page that displays the receiver's name, and any relevant receiver details, as well as the caller's callback phone number to confirm its accuracy. A “call now” link for the caller is also included to initiate the call to the receiver. In another preferred embodiment, the receiver info page may include information or issues concerning a particular campaign. Additionally, a particular campaign may have more than one receiver for a given caller and prompt the caller to prioritize the receivers in order of contact.

Once a caller follows any of the click-to-call procedures outlined above, confirms the callers identity, a callback number, and a receiver, the caller submits the call by selecting a “click-to-call” icon or identifier. Upon selecting click-to-call, the system issues an IVR command to initiate a callback to the caller's phone number. Once the caller picks up the call, the caller is connected to the IVR for interaction. By virtue of this interaction, the system can identify both the identity of the caller and the receiver with whom the caller interacts.

It is anticipated that callback calls may be made to landline phones, mobile phones, smart phones, Voice Over Internet Potocol (VoIP) phones, and VoIP software program interfaces on other types of electronic devices now known or hereinafter devised. Alternatively, in the event a caller reaches the System IVR by directly calling a dedicated campaign phone line, the IVR system can prompt the caller to enter a residence or location identifier, and the System will determine the correct receiver matching the caller's location.

When a caller is connected to the System, and the System recognizes the caller, and identifies the proper receiver for the call, the System will initiate an outbound call to the receiver. Once the receiver answers the call, the System bridges the call between the caller and receiver. It is anticipated that callback calls may be made to landline phones, mobile phones, smart phones, Voice Over Internet Potocol (VoIP) phones, and VoIP software program interfaces on other types of electronic devices now known or hereinafter devised. In one alternative embodiment, the System may present the caller with pre-recorded information, such as a message from the Organization providing instructions on how to interact with the receiver, or thank the caller for participating in the System. An embodiment wherein multiple different messages are selected for playback to callers is also contemplated.

During all call, callback and connection stages, the System will monitor the identities of the callers, and limit contact through the System by governing the individual receivers a caller may contact, provide for a maximum number of calls for each unique caller and receiver combination, and detect inadvertently dropped calls to automatically re-establish caller/receiver connection through automatic callbacks.

Once the caller and receiver are connected by the System, the caller may speak with the receiver. In the context of a political campaign, a caller may express an opinion with respect to the campaign subject matter. Once a call is complete and disconnected, the System makes a record of the call available through the Organization's System Administration dashboard, and checks to determine if the campaign requires the caller to connect with another receiver, for instance other political representatives. If the caller is to connect with additional receivers, the System will call the caller back and suggest that they speak with the next receiver. In one embodiment, audio generated during the call may be retained by the Organization.

After the caller completes one or more calls, the System will contact the caller to provide feedback, for instance to thank the caller for participating in the call, or to solicit future support. Alternatively, the System may connect the caller to a live representative from the Organization to thank the caller for participation. The follow-on message from the Organization to the caller may also include a solicitation for the caller to donate to causes relevant to the call. If a caller elects to make a donation, the System can either connect the caller with a live person, permit the caller to donate through an automated system wherein the caller may use registration information to confirm billing, or enter credit card or other financial information. Using the system, donations of various amounts, and payments using multiple payment methods may be implemented.

In the event an unregistered caller bypasses the System registration process and speaks with a receiver, the unregistered caller's follow-on call will include a callback by the Organization to thank the caller for participation and prompt the caller to create a system account as well as register for additional campaigns. As callers register with the System, all relevant information about the callers will be cataloged in a database, including caller identifying information, receiver identifying information, call information including total number of calls and the time, date and duration of each call. The cost of a call may also be calculated in the event calls are billed for connection time.

### BRIEF DESCRIPTION OF THE FIGURES

FIG. 1 is a flow chart of the method.

FIG. 2 is a flow chart of a privacy protected embodiment of the method.

FIG. 3 is a flow chart of an embodiment of the method for use in elections.

FIG. 4 is a flow chart of an embodiment of the method used for multi-mode voter identification.

### DESCRIPTION

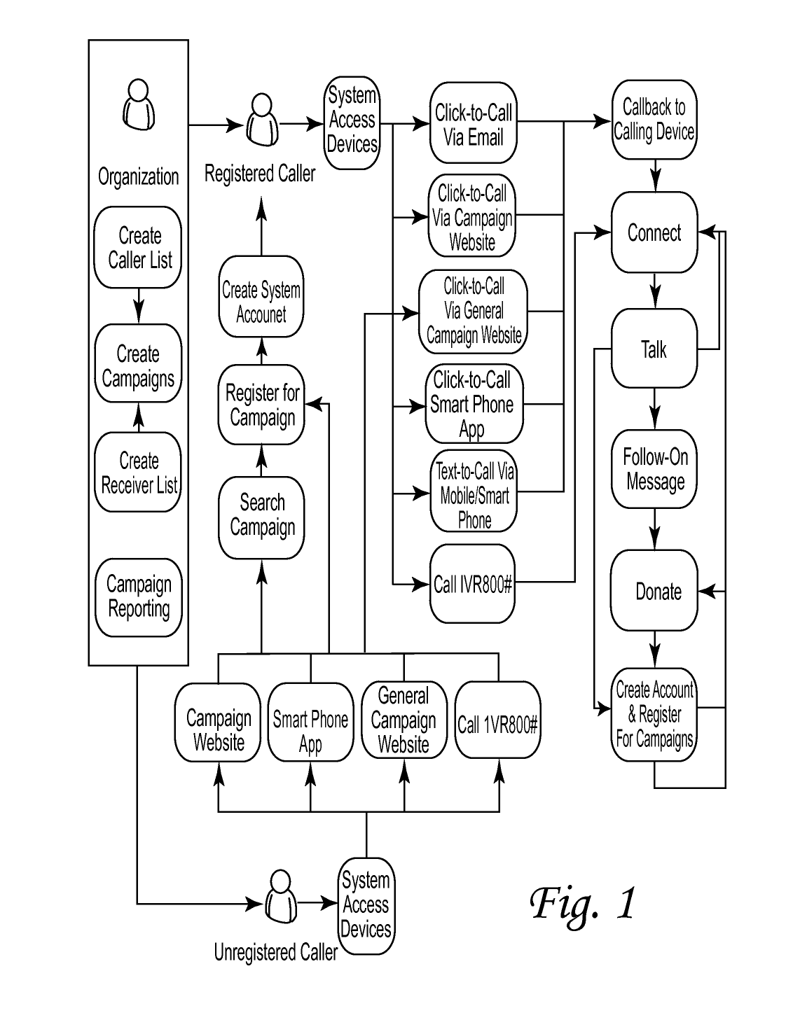

The present invention is directed toward a system of managing campaigns in a manner permitting measurement of campaign effectiveness and fostering campaign participation. Referring to FIG. 1, an organization creates a campaign. It is anticipated, by way of example that a campaign may be for polling purposes. For instance voting for a particular public office or proposed law is contemplated, however it is also anticipated that users of the system may contact representatives to express opinions on current issues, or other non-political uses.

To engage in the method, an organization wishing to advocate or provide a polling service creates a caller list comprising a list of individually identified registered callers which may be constituents. The organization also creates a receiver list of individually identified caller targets, such as political representatives. The organization then creates a campaign wherein callers are connected with their targets. It is anticipated that an organization may not be associated with a pre-populated caller list. Callers must be registered before moving to the next steps in the method.

Unregistered callers use system access devices to access the organization and register for campaigns. It is anticipated that a system access device may comprise the campaign website itself, a smart phone application, and general website, or an interactive voice response system, such as an automated “800” number. Using the above methods, an unregistered caller may create a system account, register for a campaign, and/or search existing campaigns for which they are eligible to participate.

Upon registration, callers receive a display name comprising a pseudonym. The display name is a proxy for the real identity of the caller. Likewise, receivers may also receive a display name. In this manner, a caller and receiver are not required to reveal their actual phone numbers when communicating via the system. When a caller selects a receiver using the click to call feature, the organization automatically recognizes the receiver's preferred phone number, allowing the receiver's telephone number to remain anonymous.

Returning to the organization 1, creating a caller list is now discussed in more detail. A caller, defined as any individual using the system to contact a political representative or other influential stakeholder on behalf of the organization. Caller lists may be created in several ways: Caller identifiers comprising uniquely assigned to individual caller data may be used. In this manner, identity could be any single data element, such as a first name, last name, email address, phone number, social security number, date of birth, etc. Multiple data elements are also contemplated. Second, a caller list may be generated using pre-selected individuals from an existing system database. For larger campaigns, large lists of names may be loaded into the organization's system database through an automated electronic batch loading process. In this manner, the organization has the capability to pre-register an entire list of members for specific campaigns, which is useful in situations where campaign themes overlap, for example in support of environmental causes.

It is also anticipated that campaigns may be initiated without a pre-loaded caller list, whereby caller lists are created in real time. One example of such a case is where an organization generates advertising or other media hyperlinked from a pre-existing distribution list. Because callers in this situation are unregistered, it is anticipated that dialogue boxes and other prompts to secure websites will be incorporated into the registration step.

Once the caller list is populated, the receiver list is created. It is anticipated that the receiver list, like the caller list, will employ a proxy system to identify receivers contacted by the callers. In the case of callers contacted elected representatives, the proxy may be the same as their actual identities. Otherwise the receiver proxy may be simply an alpha-numeric text. Also like the caller list, receivers may be manually entered, incorporated from a pre-existing database, or loaded from a large list of receiver names.

Once callers and receivers have been identified, a campaign can be created. Campaigns are created by assigning a campaign identity by name or number. Thereafter, caller lists and receiver lists are assigned from lists existing in the database. Once the caller lists are selected, a description of the campaign is established to define the campaign and provide callers and receivers campaign information. Parameters for starting, stopping and the duration of the campaign are also entered. Finally spend limits for the campaign are established, including the total maximum dollar amount of the campaign, total minutes called during execution of the method, the maximum minutes per call using the system, and the maximum number of dollars spent using the system.

The caller lists, receiver lists and campaign having been created, the organization begins contacting callers. Callers may be contacted by email, telephone, text message, multimedia text message, or other known forms of contact. Callers typically will use electronic devices to receive calls. Such devices might include landline phones, mobile phones, smart phones capable of Internet and other specialized communication, laptop or desktop computers, portable computers such as tablet PCs. In the event of a campaign targeting unregistered callers, the system can use the same types of communication to promote a campaign.

Still referring to FIG. 1, an unregistered caller may use access devices such as a landline phone, mobile phone, smart phone, computer or tablet PC to contact the organization. By contacting the organization through a website, smart phone application, or interactive voice response phone number, a new user can register and gain entry into the system. It is anticipated that prior to registration, the new user will be able to search the organization for one or more campaigns of interest and register for those specific campaigns. After finding one or more campaigns of interest, the user will be prompted to register.

In the alternative, an unregistered caller may simply register for a campaign and then create a system account, allowing the caller to research other campaigns. In another embodiment of the method, the organization may permit unregistered callers to bypass the campaign and account registration steps and proceed directly through the system interface hosted by the organization to initiate phone contact with a receiver of interest. In this instance, the caller would register after contact with a receiver is made.

Registered callers and unregistered callers having created an account are then prompted to initiate telephone contact. System access devices used to make contact include, but are not limited to landline phones, mobile phones, smart phones, laptop or desktop computers or tablet PCs. Several system access channels are proposed.

### System Access Methods:

Email click-to-call involves a caller receiving an email with one or more web-enabled hyperlink active buttons with messages such as “click here to call your representative.” These hyperlinks have embedded information that uniquely identifies the caller, campaign, and receiver. After clicking the hyperlink, the caller may be required to enter or confirm a callback phone number.

Click-to-call via a campaign website involves a caller visiting the website of the organization administrator and finding one or more webOenabled hyperlinks with messages such as “click here to call your representative.” These hyperlinks have embedded information that uniquely identifies the caller, campaign, and receiver. After clicking the hyperlink, the caller may be required to enter or confirm a callback phone number.

Click-to-call via a general campaign website 14c involves a caller going to a more generalized site run by the organization where one or more hyperlinked connections allow a visitor to reach different campaigns. These hyperlinks also have embedded information that uniquely identifies the caller, campaign, and receiver. After clicking the hyperlink, the caller may be required to enter or confirm a callback 17 phone number.

Click-to-call via smart phone application involves a caller using a smart phone application to cast a vote. The application may present the user with one or more web-enabled hyperlinks. These links have embedded information that uniquely identifies the caller, campaign, and receiver. After clicking the hyperlink, the caller may be required to enter or confirm a callback phone number.

Text-to-call via smart phone application 14e uses text-to-call functionality to generate a callback. This type of system involves a caller sending a text message to a predetermined text message address to cause a callback. In the alternative, a user may first receive an initial text message from the organization and may reply to this message with a yes/no response, for example by sending a “1” for yes and a “2” for no. Once a callback is triggered, the system automatically determines the user's phone number from the address of the text message. The system then initiates a callback to the user an calls the user at the phone number used to send the text message. In the alternative, if the user includes a callback number in the body of the text, the system can call back the user at whatever number is specified in the text message. In other preferred embodiments, the text message may also include one or more web-enabled hyperlinks with embedded information that uniquely identifies the caller, campaign, and receiver. After clicking the hyperlink, the caller may be required to enter or confirm a callback 17 phone number. It is also anticipated that other message services such as a Short Message Service (SMS), Multimedia Messaging Service (MMS) or similar protocol may be used for text-to-call communications.

Finally, it is possible to initiate a call back using an interactive voice response (IVR) number, such as an automated “800” type phone number. This type of caller option is intended for callers who are not able to make mobile/smart phone or computer contact. Once a caller connects to the IVR system, the caller can be instructed to enter identifying indicia such as a caller account number or PIN number which will identify the caller to the system. Also, if an unregistered caller contacts the system in this manner, they may be required to provide registration information prior to making a callback command.

### Click-to-Call Contact Procedures:

The steps involved in the click-to-call contact procedures are as follows: First a caller views a hyperlink within an email, text message, multimedia text message, smart phone application or other media. The hyperlink typically will contain a call instruction, such as “contact your representative.” Built into the link, an identification code identifies the caller, the receiver, and the campaign. The hyperlink can be configured to be used once or multiple times, in the event callers call multiple times before the receiver is contacted.

After receiving a campaign hyperlink, a caller selects it and is directed to an identification page. Registered callers may simply enter an email address or other indicia capable of being matched to the system database. Once identified, the caller may then be redirected to a caller information page populated with data reflecting the identity of the caller. At this stage, empty fields can be filled in by the caller for submission.

In the event the caller is unregistered, the unknown caller is prompted to complete a registration form. Registration can be as limited as requiring a caller name, or may be detailed, comprising the caller's name, address, phone number, etc. Upon submission of the identifying information, the system will add the newly registered caller to the system database. At this point, the organization will have the option of manually verifying the identity of and approving the caller, or bypass verification and transmit a “welcome” registration message. It is anticipated that the “welcome” message will comprise a hyperlink directing the caller to the caller information page.

Once a caller's identity has been confirmed, and the caller permitted to access the caller info page, the system database will use a predetermined algorithm to select from the receiver list proper recipients germane to the particular caller. In particular, the database may search the receiver list related to a specific campaign and the caller's unique zip code or location data to find the matching receiver and return a receiver's info page that displays the receiver's name, and any relevant receiver details, as well as the caller's callback phone number to confirm its accuracy. A “call now” link for the caller is also included to initiate the call to the receiver. In another preferred embodiment, the receiver info page may include information or issues concerning a particular campaign. Additionally, a particular campaign may have more than one receiver for a given caller and prompt the caller to prioritize the receivers in order of contact.

### Callback to Calling Device Procedures:

The steps involved in the Callback to Calling Device procedures are as follows: Once a caller follows any of the click-to-call procedures outlined above, confirms the callers identity, a callback number, and a receiver, the caller submits the call by selecting a “click-to-call” icon or identifier. Upon selecting click-to-call, the system issues an IVR command to initiate a callback to the caller's phone number. Once the caller picks up the call, the caller is connected to the IVR for interaction. By virtue of this interaction, the system can identify both the identity of the caller and the receiver with whom the caller interacts.

It is anticipated that callback calls may be made to landline phones, mobile phones, smart phones, Voice Over Internet Potocol (VoIP) phones, and VoIP software program interfaces on other types of electronic devices now known or hereinafter devised. Alternatively, in the event a caller reaches the System IVR by directly calling a dedicated campaign phone line, the IVR system can prompt the caller to enter a residence or location identifier, and the System will determine the correct receiver matching the caller's location.

When a caller is connected to the System, and the System recognizes the caller, and identifies the proper receiver for the call, the System will initiate an outbound call to the receiver. Once the receiver answers the call, the System bridges the call between the caller and receiver. It is anticipated that callback calls may be made to landline phones, mobile phones, smart phones, Voice Over Internet Potocol (VoIP) phones, and VoIP software program interfaces on other types of electronic devices now known or hereinafter devised. In one alternative embodiment, the System may present the caller with pre-recorded information, such as a message from the Organization providing instructions on how to interact with the receiver, or thank the caller for participating in the System. An embodiment wherein multiple different messages are selected for playback to callers is also contemplated.

During all call, callback and connection stages, the System will monitor the identities of the callers, and limit contact through the System by governing the individual receivers a caller may contact, provide for a maximum number of calls for each unique caller and receiver combination, and detect inadvertently dropped calls to automatically re-establish caller/receiver connection through automatic callbacks.

Once the caller and receiver are connected by the System, the caller may speak with the receiver. In the context of a political campaign, a caller may express an opinion with respect to the campaign subject matter. Once a call is complete and disconnected, the System makes a record of the call available through the Organization's System Administration dashboard, and checks to determine if the campaign requires the caller to connect with another receiver, for instance other political representatives. If the caller is to connect with additional receivers, the System will call the caller back and suggest that they speak with the next receiver. In one embodiment, audio generated during the call may be retained by the Organization.

After the caller completes one or more calls, the System will contact the caller to provide feedback, for instance to thank the caller for participating in the call, or to solicit future support. Alternatively, the System may connect the caller to a live representative from the Organization to thank the caller for participation. The follow-on message from the Organization to the caller may also include a solicitation for the caller to donate to causes relevant to the call. If a caller elects to make a donation, the System can either connect the caller with a live person, permit the caller to donate through an automated system wherein the caller may use registration information to confirm billing, or enter credit card or other financial information. Using the system, donations of various amounts, and payments using multiple payment methods may be implemented.

In the event an unregistered caller bypasses the System registration process and speaks with a receiver, the unregistered caller's follow-on call will include a callback by the Organization to thank the caller for participation and prompt the caller to create a system account as well as register for additional campaigns. As callers register with the System, all relevant information about the callers will be cataloged in a database, including caller identifying information, receiver identifying information, call information including total number of calls and the time, date and duration of each call. The cost of a call may also be calculated in the event calls are billed for connection time.

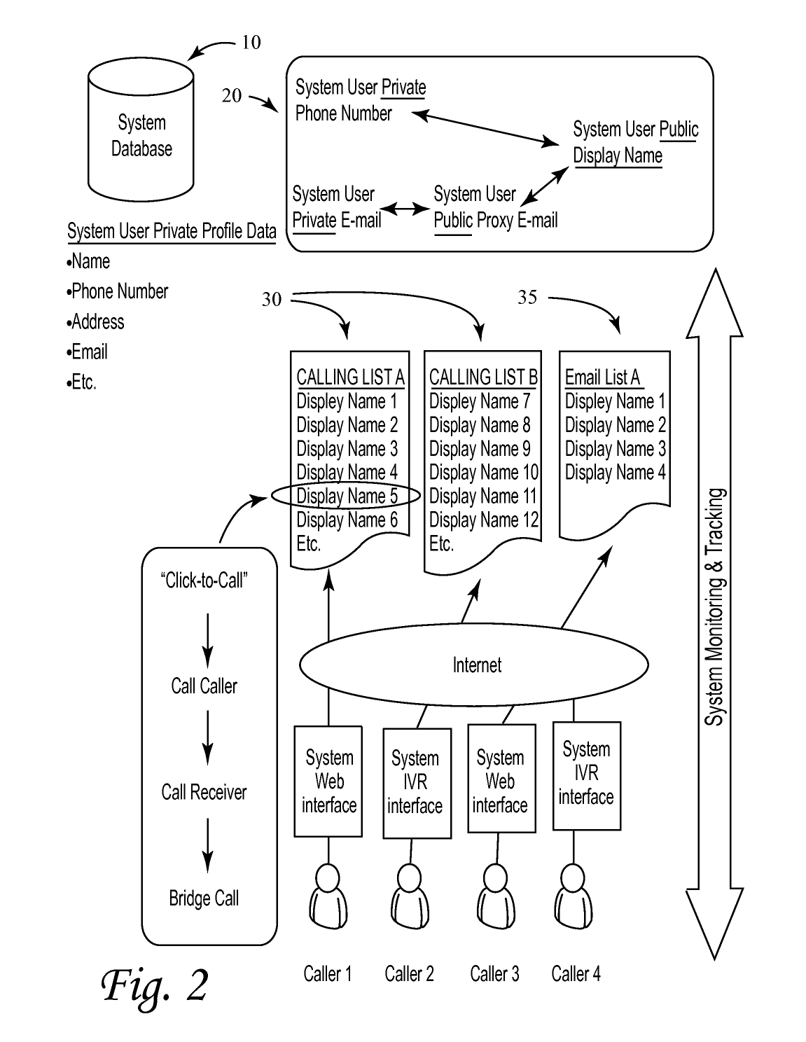

Referring to FIG. 2, an embodiment using the System to distribute calling and email lists in a large scale privacy-protected manner is shown and described. A key System feature allows quick distribution and sharing of multiple calling lists (receiver display names) to geographically dispersed callers while protecting the privacy of the receivers' phone numbers, by not distributing actual phone numbers as part of a calling list. Similarly, the System allows quick distribution and sharing of multiple email lists (receiver display names) to geographically dispersed email senders acting on behalf of the Organization while protecting the privacy of the receiver's email address, by not distributing actual emails as part of the email list.

Five key features of the System enable the large scale, privacy-protected distribution of calling lists and email lists. First, the System centrally manages in a system database 10 the private information of all System users, including phone numbers, emails, address, etc. Second, the System uses display names 20 to serve as proxies for receivers' actual personal information, including preferred contact phone numbers and email addresses. For IVR interactions, the system uses a unique system extension number for identifying the receiver.

Third, the System is Internet-based and uses the Internet to share, distribute, and manage multiple calling lists 30 and email lists 35 to geographically dispersed callers. Fourth, the System uses calling list comprising a list of receiver display names so that when a caller calls a receiver via click-to-call or IVR, the System automatically correlates the receiver's display name to the preferred contact phone number registered in the System for the receiver, and the System dials that number directly. It is anticipated that phone number can be for multiple calling modes, including landline phones, mobile phones, VoIP phones, etc. Finally, the System uses an email list comprising a list of receiver display names so that when a caller emails a receiver on behalf of the Organization, the System automatically sets up unique proxy email addresses for both caller and receiver, so that they may correspond with each other using the proxy email, while the private emails of both caller and receiver are kept private.

Still referring to FIG. 2, private personal information, including contact phone numbers and emails, for all callers and receivers are centrally maintained in the System's one or more databases 10. For each Caller or Receiver, a display name is created in the System 20. The display name serves as a proxy for the actual user profile information of the caller or receiver as registered in the System, including the preferred contact phone number and email address. All subsequent interactions between callers and receivers are performed using display names, allowing callers and receivers to maintain private personal information while still being able to contact and call and/or email each other.

Multiple calling lists can be created for distribution to multiple callers. A calling list is a list of receiver display names. Since the System automatically correlates receiver display names to the preferred contact phone number as registered in the System, the Display Name is simply a proxy for the phone number, which in turn, allows the Calling List to be comprised of a list of Display Names. When using the System's web interface, the Calling List is a list of web hyperlinked Display Names. When using the System's IVR interface, the Calling List is pre-programmed into the User's account and calls are initiated automatically by the IVR based on that list of Receivers to call.

Calling lists are accessed by multiple means, including using the System's web interface or the IVR interface. Each calling list can be accessed by one or more authorized callers as defined by the organization. Organizations may create and distribute calling lists by simply defining the callers authorized to access each list. If a caller uses the web interface to access a calling list, then as the caller logs into the System using a System ID and PIN, the System automatically displays all calling lists the caller is authorized to access. Similarly, if the caller is using an IVR interface and logs into the System using a System ID and PIN, the System automatically announces to the caller the list of display names available for the caller to call.

When using the web interface, a caller clicks on the hyperlinked display name and the System invokes the click-to-call function as described above. Calls are initiated first to the caller, then to the receiver, and then bridged together to allow both parties to speak together. When using the EVR interface, the calling list is held within the caller's IVR account, automatically initiating calls to receivers one at a time until the list is exhausted. All calls made in the System are monitored and tracked. Therefore, the calling lists are continuously updated in real-time as the calls are being made. At any point, new calling lists can be created and given to new callers. Therefore, caller lists may constantly change without any disruption to the overall calling campaign. Since calling lists contain no actual phone numbers, the need for special handling of the phone numbers to protect receiver privacy is obviated. All personal information for Callers and Receiver remain securely in the System database and is never shared with any party.

By sharing calling lists without private information, organizations may use the System to act as a 3^{rd} party intermediary. For instance, an organization may sell a calling list without releasing actual phone numbers. Then, to rescind the calling list, the organization can simply disable the access to the calling list without worrying whether or not phone numbers have been inappropriately used. By generating a digital record of all caller proxies, calls made and receivers, the system can monitor and track the effectiveness of the campaign.

In another example, a trusted organization wishing to sell or share its membership list with affiliates or partner organizations for the purposes of fund-raising may simply create multiple calling lists and provide the affiliates access to those lists. Then, after the campaign, the organization can simply disable the calling lists and the organization members' private phone number information would be protected.

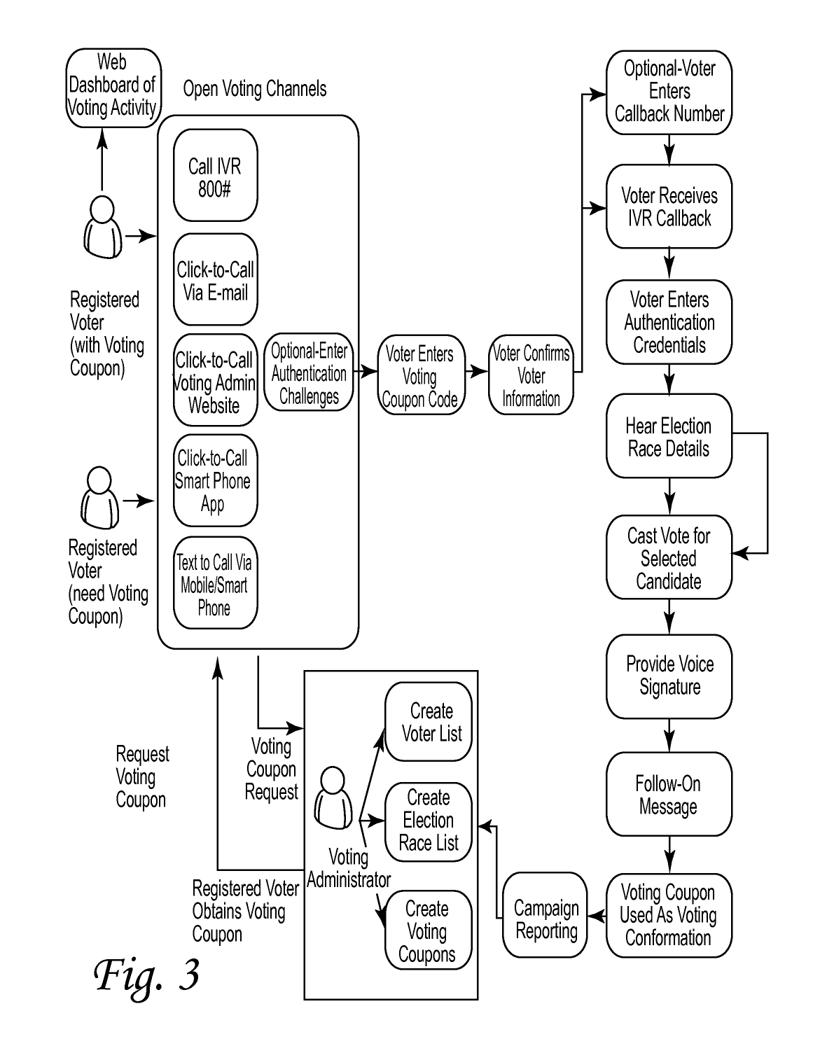

Referring to FIG. 3, an embodiment of the System employed in an election context is shown. In order to execute the election System, a voting administrator responsible for carrying out the election creates a voter list, an election race list, and voting coupons. The voter list uniquely identifies all registered voters eligible to participate in the campaign by personal information such as name, address, social security number, official ID, phone number, party affiliation, etc. The election race list defines applicable political races for a particular voter category and may include the name of the office, names of the candidates, the candidates' party affiliations and a data field for the list of the voters who selected the candidate for tallying the vote.

Voting coupons are issued to voters for particular elections and are required for vote casting. Voting coupons contain one or more coupon codes comprising a series of unique numeric or alphanumeric numbers. Voters must enter a valid coupon code to submit a vote. Since voting coupons are tied to a particular voter's identity and a particular election, the System automatically records the identity of the voter and campaign. Voting coupons may only be used once and are effective only for a predetermined period of time. Once a coupon code is input to submit a vote, it becomes a confirmation code that can be used to verify the vote.

Voters register with the voting administrator and obtain voting coupons. Voters may then call an IVR phone number such as a toll-free number to request a coupon. Alternatively, a voter may execute a click-to-call via email request, make a request through the voting administrator website, execute a click-to-call request via smart phone application, execute a text-to-call via mobile or smart phone, or make an in-person request at an authorized location.

Voters to enter their votes using multiple, openly accessible voting channels. While any voter is free to access these channels, voters must pass a series of authentication challenges before casting a vote as is the case with Multi-Mode Voter Authentication, discussed below. Only voters with proper authentication credentials may cast a vote using the System. For all voting channels, the ultimate objective is to invoke a callback to the voter allowing the voter to cast a vote by phone. Callbacks are defined as phone calls initiated by an automated IVR system and managed by a voting administrator or third party to a phone number designated by the user.

Voting Channels include: an IVR, including a toll free number for Registered Voters who prefer to use or can only access phone lines (landline or mobile). After the voter connects to the IVR system, the system may optionally require authentication credentials, including but not limited to, a voter assigned-number, temporary number password, voter PIN, registered phone number, social security number, or zip code among others. Once authenticated in the IVR system, the voter will be taken to the next step of entering one or more valid Voter Coupon codes.

Access devices for Registered Voters to call the System's IVR include but are not limited to: landline phones, mobile phones, smart phones, VoIP phones, VoIP software program interfaces, VoIP programs on Smart Phones, VoIP programs on Desktop and Laptop computers, VoIP programs on Netbooks and Tablet computers.

In the click-to-call email process, a registered voter may receive an email with one or more web-enabled hyperlink action buttons, such as “Click Here to Vote” with embedded information uniquely identifying the voter and election among other data. By selecting the hyperlink, the voter is taken to the next step of entering one or more voter coupon codes. Access devices for registered voters to receive emails with click-to-call hyperlinks include but are not limited to: smart phones, laptop or desktop computers, and other portable computers, including netbook or tablet PCs.

To use a voting administrator website click-to-call protocol, a registered voter may go to the website of the voting administrator to find one or more web-enabled hyperlink action buttons, such as “Click Here to Vote” with embedded information uniquely identifying the voter and election among other data. By selecting the hyperlink, the voter is taken to the next step of entering one or more voter coupon codes. Access devices for registered voters to receive emails with click-to-call hyperlinks include but are not limited to: smart phones, laptop or desktop computers, and other portable computers, including netbook or tablet PCs.

To use a click-to-call via smart phone application, a registered voter may use a smart phone (including any mobile device allowing users to access the Internet while also making phone calls) and smart phone application to cast a vote. The application presents the user with one or more web-enabled hyperlink action buttons, such as “Click Here to Vote” with embedded information uniquely identifying the voter and election among other data. By selecting the hyperlink, the voter is taken to the next step of entering one or more voter coupon codes. Access devices for registered voters to receive emails with click-to-call hyperlinks include but are not limited to: smart phones, laptop or desktop computers, and other portable computers, including netbook or tablet PCs.

To use a text-to-call via smart phone application, a registered voter may use the text-to-call functionality to initiate a callback and submit a vote. Text-to-call works as follows: A user sends a text message to a predetermined text message address thereby invoking a callback to the user. Alternatively, the user may receive an initial text message from the voting administrator alerting the user of eligibility to vote in the election. The user may reply to the initial text message with a positive response, for instance “1” for callback and “2” for no callback.

Receiving a positive response, the system automatically determines the user's phone number from the texts message address. The system then initiates a user callback at that phone number. Alternatively, if the user includes a Callback phone number in the body of the text, the system will call back the user at whatever number is specified. The text message may also include one or more web-enabled hyperlink action buttons, such as “Click Here to Vote” which have embedded information uniquely indentifying the voter, election, etc. By selecting the hyperlink, voters are taken to a secured webpage to enter one or more valid Voter Coupon codes. Text messages may also include short message service (SMS), multimedia messaging service (MMS), or any other protocols for sending short messages. Optionally, for each of these voting channels, additional authentication challenges specific to each channel may be required for additional security. Access devices for registered voters to receive SMS and MMS text messages with click-to-call hyperlinks include but are not limited to: smart phones, laptop or desktop computers, and portable computers including netbook or tablet PCs.

The next step in the process is for the voter to enter one or more valid coupon codes. The means of entering coupon codes may vary depending on which voting channel is used, for instance: Voters may call an IVR, including a toll-free number, and enter coupon code using the phone keypad. Using the click-to-call via e-mail functionality, selecting the “Click-to-Call” hyperlink takes voters to a secured webpage, hosted by the voting administrator, where the voter enters one or more coupon codes. Using the click-to-call via voting administrator website functionality, selecting the “Click-to-Call” hyperlink takes voters to a secured webpage, administered by the voting administrator or any other administrator running the System, where the Voter enters one or more coupon codes. Using the click-to-call via smart phone application, upon selecting the “Click-to-Call” hyperlink, voters may be taken to a secured webpage, hosted by the voting administrator, where the voter enters one or more coupon codes. Using the text-to-call via mobile/smart phone functionality, upon selecting the “Click-to-Call” hyperlink or submitting a positive text message reply, voters are taken to a secured webpage, hosted by the voting administrator, where the voter enters one or more coupon codes. Alternatively, voters may respond with coupon codes via text message.

Once the Coupon Codes are entered into the system, the system can retrieve automatically any information about the Voter that was recorded at the time of Voter registration. This registered information is then presented back to the Voter to confirm, in order to ensure that the system identified the correct Voter. For each Voting Channel, the confirmation may take place in different ways. Using an IVR number, including a toll-free number voters can listen to information played back by IVR, then press a button to confirm or reject. Using click-to-call via e-mail functionality, voters are taken to a secured webpage pre-populated with voter information. Voters can then confirm or reject. Using click-to-call via voting administrator functionality, voters are taken to a secured webpage pre-populated with voter information. Voters can then confirm or reject. Using the click-to-call via smart phone functionality, voters are taken to a secured webpage pre-populated with voter information, where a voter can confirm or reject. Using click-to-call via text message functionality, voters are sent one or more text messages containing voter information to which they may reply by text message to confirm or reject.

In one embodiment when a voter enters a callback number, an additional optional step allows voters to enter ad-hoc callback numbers. callback numbers are phone numbers where user would like to receive a call back from the system. By allowing ad-hoc Callback numbers, the Voting Administrator provides extra flexibility for the Voter in case the Voter's phone number changed since the time of Voter Registration. However, for extra security, the system would only call back phone numbers that the Voter Administrator already has on file.

For each voting channel, the callback number may be entered in many ways, including but not limited to: calling an IVR, including toll-free, number wherein a voter can enter the callback number using the number keypad and hang up the call, click-to-call via e-mail wherein the voter is taken to a secured webpage to enter the callback number, click-to-call via voting administrator website wherein a voter can be taken to a secured webpage to enter the callback number, click-to-call via smart phone application wherein a voter can be taken to a secured webpage to enter the Callback number, and click-to-call via text message wherein a voter can send one or more text messages containing Callback number in the body of the text. The Access devices for registered voters to receive callback phone calls include but are not limited to: landline phones, mobile phones, smart phones, VoIP phones, VoIP software program interfaces, VoIP smart phone programs, VoIP programs on Desktop and Laptop computers, and VoIP programs on netbooks and tablet computers.

After requesting a callback, voters receive automated IVR callbacks. Callbacks are calls, initiated automatically by an IVR system to the phone number either registered for the voter or provided ad-hoc by the voter. Since prior to this point, the voter has already entered one or more coupon codes, the system knows the identity of the voter and the applicable election in which the voter intends to Vote. The IVR system can be managed by the voting administrator or a trusted third party. Callbacks can be made to any phone number and device, including landline phones, mobile phones, or VoIP clients.

When a voter receives the callback, the voter is required to provide authentication credentials to verify the voter. These credentials may include but not limited to: permanent credentials including Social Security Number, Date of Birth, voice, etc., semi-permanent credentials including: address, zip codes, phone numbers, etc., and temporary Credentials with i) limitations on how many times they can be used, ii) having effective periods and expiration dates, and iii) having limitation on how they are used. Voting coupon codes are examples of temporary credentials. Coupon codes can be used only once per vote, have effective periods and expiration dates, and can be used only for specific election race.

After passing the authentication challenges, a voter can listen to details of the election race specific to the Voter, based on information known about the Voter, including registered district, etc. After hearing the election race details, the system will then state the name of the office of the first applicable political race. The system will draw from an election race list the candidates and party affiliations, prompting the voter to select a candidate. The selection may be made by pressing a number on the keypad corresponding to a candidate, saying a number corresponding with a candidate, or saying the candidates name directly. Voters may also select a ‘not to vote in this race at this time’ option and be informed as to where they may obtain further information on the race and candidates. If a candidate is selected, the system will restate the selected candidate's name and prompt the voter to confirm the selection.

After completing the voting process for the first election, a record of the call by the voter along with the corresponding vote is save in the System database and made available for voting administrators to access and view later. If the election requires the voter to vote on another candidate or issue, the system returns to the preceding step and plays the details for the next election. This process will repeat until the voter has exhausted all eligible election races, or disconnects. If the voter already voted, the System notifies the voter and instruct the voter to go to a secure web page, also called a “dashboard,” to view the details of the cast ballot. Additionally, the System will be able to recognize elections in which the voter has voted and which elections remain. If any elections remain, the System prompts the voter to vote on those races.

After all applicable votes are cast the System may playback all votes to ensure no errors have been made. Any vote cast in error may be changed. Once all votes are correct, the System prompts the voter to make a voice recording, which serves as a certification “signature.” All voice signature recordings are stored in the System database, which keeps track of votes made for each election. Additionally, each vote is accompanied by the voice signature, along with the vote's time and date, phone number used for casting the vote, and duration of phone call for casting the vote.

After the caller has finished, the System calls back the caller to provide feedback, which may include a recorded message thanking the caller for participating and/or to solicit future support. Alternatively, the System may also initiate a callback to the caller and connect the caller to a live person who thanks the caller for their participation.

Once the votes have been cast and voice signature recorded, the voting process is complete and voters may now use their voting coupon codes as confirmation codes. The voting administrator can use confirmation codes to retrieve all relevant information about cast votes, including voter info, election, vote time and date, actual votes, etc.

As callers are registered into the System and calls made through the System, the System database records all relevant information about callers and calls and provides a full report of the campaign, detailing each call with caller and receiver information, as well as call information such as the total number of calls and the time, date and duration of each call, and cost of call where applicable.

The system will also provide a website allowing voters to log in to their accounts at any point in the voting process and 1) view the details of the races for which they are eligible to vote, 2) view the races they have not yet voted in, 3) view the races they have already voted for and the candidates for whom they have voted, and 4) provide the applicable click-to-call links for voters to call and cast their remaining votes.

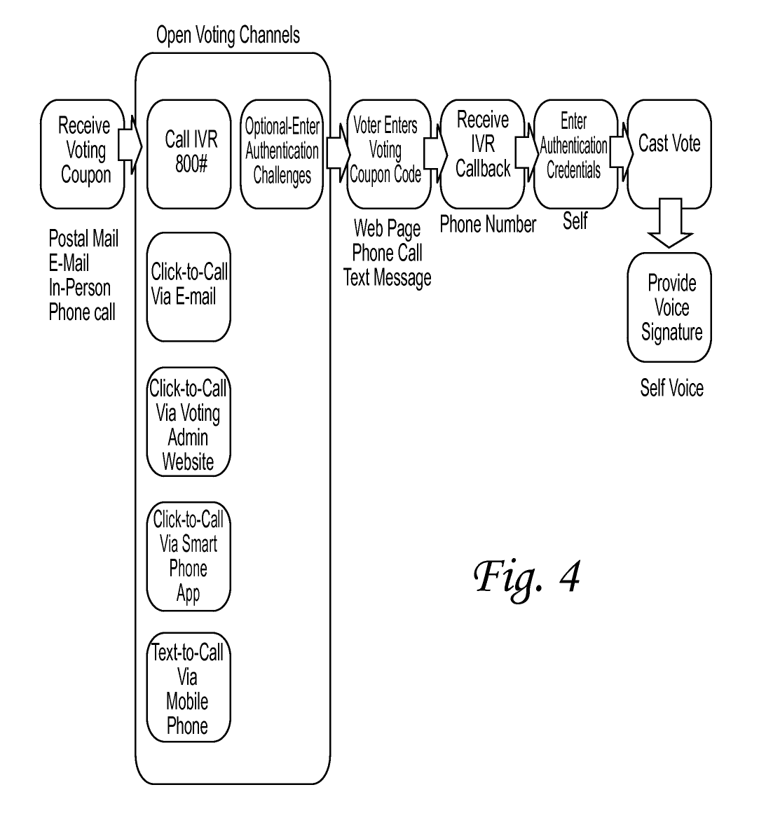

Referring to FIG. 4, in another embodiment, the System may be used as a Multi-Mode Voter Authentication (MMVA) platform. The MMVA process uses multiple authentication challenges during the voter authentication process, requires voters to supply multiple authentication credential types (permanent, semi-permanent, and temporary) when responding to authentication challenges, and use more than one type of communication when interacting with the System during the authentication process. These interactions may include but are not limited to: a voter requesting authentication credentials, receiving authentication credentials, voter contact for authentication challenges, and responding to authentication challenges. Communication modes for interacting with voters in the MMVA process include but are not limited to: postal mail, e-mail, conventional phone calls, text messaging, and in-person communication. By using unique combinations of authentication credential types and communication modes, MMVA avoids any single failure point in the event that one mode is compromised. MMVA can also be generalized as Multi-Mode User Authentication (MMUA) and applied to non-voting processes that require authenticating any type of users as discussed below.

In the MMVA election process, several authentication challenges are used and shown in FIG. 4. In the first authentication challenge, a voter to receives a voting coupon 1 via one of several communication modes, including but not limited to, postal mail, e-mail, or in-person at a location certified by the voting administrator. The secondary challenge, similar to the above embodiments, is to call a toll-free IVR, click-to-call via email, click-to-call via voting administration website, click-to-call via smart phone application, or text-to-call via mobile phone. As a secondary option, for each voting challenge, there may be additional authentication challenges specific to the voting channel, such as a secure post office box.

The third authentication challenge requires the voter to enter one or more voting coupon codes 3. In additional to this temporary authentication credential, the communication mode for entering the voting coupon differs from the communication mode used to receive the voting coupon code. For instance, a voter may receive a voting coupon code by postal mail and call the IVR to enter the voting coupon code by phone.

The fourth authentication challenge requires the System to initiate an automated voter callback 4. This challenge is designed to: 1) initiate calls from trusted sources and 2) ensure a valid phone number for the voter to receive the callback and continue voting. To address fraud, the phone number may be traced to an account holder for identifying abuse. The authentication mode of using a valid phone number may be different from the modes used in the preceding challenges.

In a fifth authentication challenge, the voter enter an authentication credential after answering the callback 5. Authentication credentials may be permanent, semi-permanent, or temporary. Since a temporary credential (such as a voting coupon code) is employed in prior steps, a permanent credential (e.g., social security, date of birth, voice, etc.) should be used for this step.

After the voter casts the vote, the sixth authentication challenge causes the voter to leave a voice signature 6 confirming the voter's identity in relation to the cast vote. The System saves the voice signature as a voice recording and can be analyzed to match the voter's voice to disprove fraud.

In a final embodiment of the invention similar to MMVA, the System uses click-to-call and temporary credentials in a multi-mode user authentication (MMUA) process wherein the System is adapted to authenticate users in a non-voting processes. In this manner, click-to-call and temporary credentials can be combined to provide an added measure of security to any MMUA process.

At any point during a web-based process such as online voting or shopping, a user may select a click-to-call icon to invoke a callback. The user may be prompted to enter a valid callback phone number, or the callback can be made to a pre-registered number. Users answering the callback hear a numerical code serving as a temporary credential. The user is then required to enter the newly obtained numerical code. If the correct code is entered, the user may proceed to the next step of the web-based process.

What is claimed is:

1. [either registered or unregistered callers] A method of mobilizing large scale campaigns comprising the steps of:
an organization identifying a list of at least one caller, a list of at least one receiver, and a campaign, said at least one caller selected from the group consisting of registered callers and unregistered callers;
said organization automatically contacting at least one caller from said at least one caller list, and causing said at least caller to contact a predetermined at least one receiver chosen from said receiver list;
said at least one caller communicating with said at least one receiver; and
when contact is broken between said at least one caller and said at least one receiver, said organization being automatically re-connected and communicating a message to said at least one caller.

2. The method of claim 1 wherein said receiver list comprises a preloaded database of pre-selected receivers having at least one common attribute.

3. The method of claim 1 wherein a non-listed unregistered at least one caller contacts said organization and registers prior to said automatic contact.

4. The method of claim 1 wherein an unregistered at least one caller accesses said organization through a system access device selected from the list of land line phone, mobile phone, smart phone, laptop computer, desktop computer, and tablet computer.

5. The method of claim 1 wherein an unregistered at least one caller accesses said organization and become registered through an access channel selected from the list of campaign website, smart phone application, third party website, and interactive voice response phone number.

6. The method of claim 1 wherein said at least one caller may search said organization for a specific campaign, with registration operating as a prerequisite to connection.

7. The method of claim 6 wherein an unregistered said at least one caller may select a campaign prior to registration or register prior to campaign selection, prior to connection.

8. The method of claim 1 wherein an unregistered said at least one caller may connect to said at least one receiver and register after connection.

9. The method of claim 1 wherein an automatic callback system is used to connect said at least one caller with said at least one receiver.

10. The method of claim 9 wherein said automatic callback system is an access channel chosen from the list of click-to-call via email by single use email link, click-to-call via email by multiple use link, click-to-call via campaign website, click-to-call via third party website, and click-to-call via smart phone application, whereby once said at least one caller confirms his identity, said organization contacts said at least one receiver and said at least one caller to bridge a call between them.

11. The method of claim 9 wherein connection is made using text-to-call via a mobile smart phone, whereby a user sends a text message invoking a callback or a user first receives an initial text message to which the user may affirm connection; said organization automatically determining the identity of the user and initiating a callback to said user; or said text message includes a web-enabled hyperlink through which the user may confirm his identity.

12. The method of claim 8 wherein connection is made using an interactive voice response phone connection.

13. The method of claim 1 wherein upon identifying said at least one caller, said organization automatically predetermines the appropriate at least one receiver to whom said at least one caller should be connected.

14. The method of claim 1 wherein said organization provides information to said at least one caller relevant to contact with said at least one receiver prior to connecting said at least one caller with said at least one receiver.

15. The method of claim 1 wherein said organization generates and delivers to said caller a “thank you” message following said connection between said caller and said receiver.

16. The method of claim 1 wherein said organization serves as a certifying entity, certifying all calling activities, including actual calls attempted by callers through the system, completed calls between callers and receivers, and total call time between callers and receivers.

17. The method of claim 16 wherein in the event an organization pays for system usage, call information can be used as a basis for determining usage charges for the system, and, in turn, certify the use of funds spent by the organization in furtherance of said campaign.

18. The method of claim 1 wherein said organization generates and delivers to said caller a donation solicitation following said connection between said caller and said receiver.

19. The method of claim 1 wherein said organization employs a computing means for generating statistical reports, whereby said reports generate a feedback mechanism for eliminating call reproduction.

20. A method of distributing and sharing multiple calling lists comprising the steps of:
providing an organization with a system database comprising private profile data for a plurality of users;
each user having a proxy identifier associated with said private profile data, including display name proxy data and IVR extension number proxy data as applicable;
said organization creating at least one caller list using said private profile data, said users defined by at least one common characteristic, and said caller list including said proxy identifiers;
said organization distributing said caller list to a communications device, wherein said communications device is employed to contact users;
said user contact comprising a request for said user to initiate contact with said organization to be connected with at least one predetermined receiver; and
all instances of contact monitored by said organization using said proxy identifiers, whereby said organization obtains individualized connection information, which is used through a feedback loop to continuously update said caller list in real time.

21. The method of claim 20 wherein said organization employs caller email to serve as a proxy identifier for said private profile data.

22. The method of claim 21 wherein information from said feedback loop pertaining to said caller list is incorporated into subsequent caller lists.

23. The method of claim 22 wherein said contact initiation requests are accomplished through a process chosen from the list of click-to-call, text to call, and interactive voice response.

24. A voting and/or polling method comprising the steps of:
a voter administrator creating a voter list, creating an candidate list, and creating voting coupons individually corresponding to individual voters in said voter list;
a voter characterized as either needing a voting coupon or having a voting coupon accessing a voting channel, said coupon needing voter requesting and obtaining a voter coupon from said administrator prior to interacting with said voting channel;
said voter entering voting coupon information and receiving identity confirmation from said administrator, then providing authentication credentials, then casting a vote for at least one candidate from said candidate list;
said voter providing a voice signature authorization, confirming the accuracy of said vote; and
said voter receiving follow-on information from said administrator, wherein said voting coupon serves as a voter voting confirmation, and a proxy to individually identify said voter in a campaign report.

25. The method of claim 24 wherein said voting channels are chosen from the list of interactive voice response, click-to-call via email, click-to-call via e-mail, click-to-call via smart phone application, text-to-call via texting feature, and direct pass through to coupon code entry.

26. The method of claim 24 wherein upon supplying voting coupon information, said voter enters callback information to be contacted by said administrator.

27. The method of claim 24 wherein upon entering said voting coupon, said voter is provided information related to said candidates.

28. The method of claim 24 wherein upon providing a voice signature, said voter receives a follow-on message that may be customized for each voter.

29. The method of claim 24, wherein the voting coupon information pertaining to said voter differs from said authentication information provided after securing said voting channel.
